(19) United States
(12) Patent Application Publication
(10) Pub. No.: US 2026/0153762 A1
(43) Pub. Date: Jun. 4, 2026

(54) LIGHT FILTER AND LIGHTING DEVICE AND SCREEN HAVING SUCH A LIGHT FILTER

(71) Applicant: siOPTICA GmbH, Jena (DE)

(72) Inventor: André HEBER, Weimar (DE)

(21) Appl. No.: 19/121,494

(22) PCT Filed: Dec. 18, 2023
(86) PCT No.: PCT/EP2023/086266

§ 371 Date: Apr. 16, 2025

(30) Foreign Application Priority Data
Dec. 20, 2022 (DE) 10 2022 134 123.2

(51) Int. Cl. G02F 1/13; G02B 5/30; G02F 1/1335; G02F 1/13357; G02F 1/13363; G02F 1/137

(52) U.S. Cl. CPC G02F 1/1323; G02B 5/3083; G02F 1/133528; G02F 1/133606; G02F 1/133634; G02F 1/13731

(57) ABSTRACT

A light filter including first and second optical elements having light-absorbing transition dipole moments orientated with a tolerance of at most 20° parallel to a first direction for the first optical element and for the second optical element parallel to a second direction so light incident in the first or second optical element is transmitted or partially absorbed, depending on its direction of incidence relative to the respective element and its polarization state. A delay layer is between the elements as a C- or A-plate so that at least 85% of linearly- or elliptically-polarized light incident into the light filter at an angle of at least 35° to the first or second direction is absorbed, wherein the angle between the electric field of the linearly-polarized light or long half-axis of the elliptically-polarized light and the direction of incidence, projected onto the surface of the light filter, is less than 20°.

### PRIORITY CLAIM

The present application is a National Phase entry of PCT Application No. PCT/EP2023/086266, filed Dec. 18, 2023, which claims priority from German Patent Application No. 10 2022 134 123.3, filed Dec. 20, 2022, the disclosures of which are hereby incorporated by reference herein in their entireties.

### BACKGROUND OF THE INVENTION

In recent years, great strides have been made to widen the visual angle in LCDs. However, there are often situations in which this very large viewing area of a display screen can be disadvantageous. Increasingly, information such as bank data or other personal information and sensitive data is also available on mobile devices, such as notebooks and tablets. Accordingly, people need to supervise viewing access to these sensitive data. They should be able to choose between a wide viewing angle—a public mode—for sharing information on their display with others, e.g., when viewing vacation photographs or for advertising purposes. On the other hand, they need a small viewing angle—a private mode—when they want to treat the displayed information confidentially.

A similar problem arises in the automotive industry, where the driver should not be distracted by image contents, e.g., digital entertainment programs, when the engine is running, but the passenger would like to view such images during the drive. Consequently, there is a need for a display screen that can toggle between the corresponding display modes.

Add-on films based on microlouvers have already been used for mobile displays in order to achieve protection of visual data. However, these films were not switchable or toggleable; they always had to be manually applied first and then removed again subsequently. They also had to be transported independently from the display when not in use at a particular time. A further substantial drawback in the use of such louvered films is connected to the associated light losses.

U.S. Pat. No. 6,765,550 B2 describes such a protected view by means of microlouvers. The greatest disadvantage here is the mechanical removal and mechanical mounting of the filter and the light losses in protected mode.

U.S. Pat. No. 5,993,940 A describes the use of a film which has small strip-shaped prisms arranged uniformly on its surface in order to achieve a privacy mode, i.e., a limited viewing mode with a small viewing angle area. The development and production are quite cumbersome in terms of technology.

In WO 2012/033583 A1, switching between public view and restricted view is brought about by means of controlling liquid crystals between chromonic layers. There is light loss and the technical expenditure is quite high.

US 2012/0235891 A1 describes a very elaborate backlight in a display screen. According to FIGS. 1 and 15, not only is a plurality of light guides utilized but also additional complex optical elements such as microlens elements 40 and prism structures 50 which modulate light as it travels from the back illumination to the front illumination. This is expensive and technically complicated to implement and also involves light losses. According to the variant shown in FIG. 17 in US 2012/0235891 A1, both light sources 4R and 18 produce light with a narrow illumination angle. For this purpose, the light from the back light source 18 is first transformed in a costly manner into light with a large illumination angle. This complex transformation sharply reduces brightness as already noted above.

According to JP 2007-155783 A, special optical surfaces 19 which are difficult to calculate and produce are used to deflect light in different narrow or wide areas depending on the incident angle of light. These structures resemble Fresnel lenses. Further, there are interference edges which deflect light in unwanted directions. Accordingly, it remains unclear whether or not meaningful light distributions can actually be achieved.

US 2013/0308185 A1 describes a special stepped light guide which radiates light onto a large area in various directions depending on the direction from which it is illuminated proceeding from a narrow side. Accordingly, in combination with a transmissive imaging display unit, e.g., an LC display, a display screen can be produced that is switchable between a public viewing mode and a limited viewing mode. One of the drawbacks here consists in that the limited-view effect can only be produced for left and right or up and down, but not for left and right and up and down simultaneously as is needed for certain payment processes, for example. In addition to this, a residual light is also always still visible in the limited-view mode from blocked viewing angles.

Applicant's WO 2015/121398 A1 describes a display screen with two modes of operation in which scattering particles are present in the volume of the corresponding light guide for toggling between operating modes. However, the scattering particles selected therein, which comprise a polymerizate, generally have the disadvantage that light is coupled out of both large areas so that about half of the useful light is radiated in the wrong direction, namely, toward the backlight, and cannot be recycled there to a sufficient extent because of the construction. Beyond this, the scattering particles of polymerizate which are distributed in the volume of the light guide can lead under certain circumstances, particularly at high concentrations, to scattering effects which diminish the privacy effect in the protected operating mode.

The technological approach of “electrical birefringence” is based on the idea of using the switchable liquid crystals of an additional LC panel to “filter” all of the light rays which do not exit the imaging layer at a determined emission angle. The disadvantages of this technology include the high additional expenditure of energy and the high cost and the fact that the +/−40° “sweet spot”, i.e., the best possible viewing position, is difficult to modify. The absorbance of the LC structures is also insufficient because the attenuation of the light intensity increases again for viewing angles larger than the sweet spot, and the light intensity for viewing angles larger than +/−40° amount to up to 3% of the maximum light intensity.

The drawback shared by the methods and arrangements cited above is that they generally reduce the brightness of the basic display screen appreciably and/or require a complicated and expensive optical element for toggling between modes and/or lower the resolution in the freely viewed public mode and/or have visual artifacts in very high-resolution displays.

### SUMMARY OF THE INVENTION

Therefore, it is an object of the invention to describe a light filter having an optical element in which light that is incident into the optical element is transmitted or is partially or entirely absorbed depending on its incident direction and its polarization characteristics, but not depending on its position. The transmission of light is to be influenced in an angle-dependent manner—optionally perpendicularly with reference to a sitting or standing observer—by means of the light filters utilizing the optical element, which enables toggling between at least two operating states. In particular, the transmission behavior will be switchable for determined directions. In such optical elements of the type mentioned above which are known from the prior art and in which the directional selectivity is achieved via the polarization characteristics, it so happens that when the absorption of the electric field takes place perpendicular to the film surface, the transmission graph thereof which is plotted, for example, in false colors in a polar coordinate system takes on the unwanted shape of an hourglass. It is generally the case that the protected view cannot be decisively enhanced through the absorption of such an optical element. Accordingly, the protected view effect of this operating principle remains limited absent further improvements. Thus owing to the hourglass shape, the transmission, as measurement for the protected view, always has higher values for vertical viewing angles greater than 5° than for vertical viewing angles less than 5° for light that is linearly polarized along the horizontal direction, indeed generally for the entirety or at least the majority of the horizontal angular spectrum. Therefore, the aim of the invention is particularly to reduce the transmission for vertical viewing angles greater than 5° (i.e., to improve the protected view), while the transmission for vertical viewing angles less than 5° are to be kept the same, even with simultaneously different horizontal angles. The term “vertical” is thought of here as an exemplary reference for an observer standing or sitting in front of, and looking at, a light filter. In this case, the line joining both of the observer's eyes would define the horizontal direction as a reference. In a corresponding manner, the vertical direction as reference lies perpendicular thereto.

The above-stated object is met in a first embodiment according to the invention by a light filter which comprises a first optical element and a second optical element, each of the two optical elements respectively comprising a plurality of light absorbing transition dipole moments. The two optical elements are arranged in a stacked manner with respect to an incident direction of light, i.e., the light passes successively through them. In plate-shaped optical elements with, in each instance, two large surface areas which are framed and connected by narrow sides, the light passes successively through the large surface areas when the optical elements are arranged in a stacked manner. The stacked arrangement should not be interpreted to mean that the two optical elements lie against one another. On the contrary, according to the invention, there is at least one further element located between the optical elements as will be described later.

The majority of transition dipole moments are aligned, at least in a first state, with a tolerance of at most 20°—preferably at most 10°—parallel to a first preferential direction which is selectable for the first optical element and parallel to a second preferential direction which is selectable for the second optical element, or fluctuate/vary around them. In this connection, the predicate “at least in a first state” includes several possibilities. First, there can be exactly one state. This is a permanent configuration. However, this wording also explicitly implies that there can be two or more states. In this case, the transition dipole moments are variable with respect to their orientations, e.g., via guest-host liquid crystal cells. In this way, light which is incident into the first optical element or into the second optical element is transmitted or at least partially absorbed depending on its incident direction relative to the respective optical element and its polarization state.

Arranged between the first optical element and second optical element is a retarder layer in the form of a C-plate or A-plate with which a phase shift greater than a quarter-wavelength is generated for a given wavelength λ, for example, a half-wave layer. In every case, the phase shift must be greater than a quarter-wavelength. The given wavelength may be, for example, the design wavelength for which the light filter is optimized by means of appropriate design programs (e.g., LCD Master, Techwiz and/or using algorithms known from the prior art as in, e.g., A. Lien, “Extended Jones matrix representation for the twisted nematic liquid-crystal display at oblique incidence”, Appl. Phys. Lett. 24 Dec. 1990; 50 (26): 2767-2769 (https://doi.org/10.1063/1.103781). A green wavelength such as λ=550 nm is often chosen, although any wavelength from the visible wavelength spectrum can be used in principle.

As a result, linearly polarized light or—particularly highly—elliptically polarized light which is incident into the light filter at least at an angle of 35° to the first preferential direction or second preferential direction is at least 85% absorbed when the angle between the electric field of the linearly polarized light or long semi-axis of the elliptically polarized light and the incident direction, (both) projected onto the surface of the light filter, amounts to less than 20°.

In this connection, highly elliptically polarized light means that the ratios of the amounts of the semi-axes are at least 1:4, better yet at least 1:10 or more. It is contemplated, for example, that only linearly polarized light or highly elliptically polarized light is incident into the light filter.

The means-effect relationships for improving protected viewing based on the above-described combination, according to the invention, of the first optical element, retarder layer (A-plate or C-plate) and second optical element can be illustrated conceptually as follows: for purposes of explanation it is assumed by way of example that the absorbing transition dipole moments are aligned perpendicular to the surface of an optical element, i.e., the first preferential direction and the second preferential direction are perpendicular to the relevant optical element in each instance and are therefore identical. The first optical element absorbs substantially p-polarized electric field components. When linearly polarized light is incident into the first optical element, the light is maximally absorbed when the light is polarized exclusively in the plane of incidence. The larger the angle between the plane of incidence and the polarization direction—or, correspondingly, the vertical viewing angle—the greater the transmission. Therefore, the two-dimensional angle-dependent representation has an hourglass shape for the first optical element. A retarder layer, as A-plate or C-plate, comprising a uniaxial birefringent material whose extraordinary axis is oriented parallel to or perpendicular to the surface is now inserted after the first optical element. The light transmitted by the retarder layer is now not exclusively polarized along one of the two principal axes of the retarder plate so that s-polarized light entering through the retarder plate is at least partially transformed into p-polarized light which can be absorbed by the subsequent second optical element. Accordingly, the original hourglass shape changes to a more rectangular shape which is desirable for a better, clearer limitation of view without brightness limitations in the protected area.

The respective layer thicknesses of the materials with the absorbing transition dipole moments in the first optical element and second optical element can differ from one another. Alternatively, they can also be identical or virtually identical, that is, of course, within the scope of technical feasibility. In general, each of the optical elements also has a transparent substrate (e.g., glass or a polymer) on which the material with the absorbing transition dipole moments are located.

The transition dipole moment—also known as transition matrix element—is a quantum-mechanical vector quantity and is associated with a specific transition between an initial state—generally the basic state—and a final state—generally an excited state—of a system, i.e., of an atom, molecule or solid, and corresponds to the electric dipole moment which is related to this transition. The direction of the vector defines the polarization of the transition which, in this case, is synonymous with the polarization direction, which in turn determines how the system interacts with an electromagnetic wave of a given polarization and absorbs light of the corresponding polarization direction during the transition from the basic state to the excited state. The amount of the vector corresponds to the strength of the interaction or to the transition probability. The excited state relaxes through non-radiating processes.

The first preferential direction or second preferential direction corresponds to that orientation of the transition dipole moments of the first optical element or second optical element, respectively, with a given propagation direction of light in which the absorption is identical for any polarization directions of the light.

The first preferential direction and second preferential direction can also be identical or may differ in orientation only by a few degrees—at most 10°—and both may be perpendicular to the relevant optical element in particular. This is a preferred case. However, depending on the case of application, is also possible that the first preferential direction and second preferential direction differ by more than 10° from one another.

Further, the light filter can comprise a polarizing filter which is arranged upstream or downstream of the first optical element or second optical element in direction of incidence. When a linear polarizing filter is arranged in front of the first optical element or second optical element in direction of incidence, it provides for the linear polarization of the light incident on the corresponding optical element. On the other hand, when a linear polarizing filter is arranged downstream of the first optical element or second optical element in direction of incidence, it provides for the extinction of unwanted polarization components of the light emerging from the first optical element or second optical element. Alternatively or additionally, a quarter-wave layer is also contemplated such as upon incidence of circularly polarized light which is transformed into substantially linearly polarized light because of this layer. For example, 550 nm or 580 nm may be selected as appropriate design wavelength λ.

The light filter can further comprise means for selectively generating a first electric field EF1 or a second electric field EF2. In this way, basically two different operating modes can be realized. Upstream or downstream of the first optical element and/or second optical element is a liquid crystal layer on which the first electric field EF1 or the second electric field EF2 acts and which, depending thereon, influences the polarization state of light passing through it so that the transmission characteristics of the light filter differ between a first operating mode B1 in which the first electric field EF1 is present and a second operating mode B2 in which the first electric field EF2 is present. Further operating modes can possibly be realized if more fields can be generated.

In a preferred configuration, the light penetrating the liquid crystal layer is transmitted substantially unchanged in the presence of the second electric field EF2, while the incident light is circularly or elliptically polarized or the polarization of the light is rotated by 90° in the presence of the first electric field EF1.

The second electric field EF2 can amount to 0 V/μm, for example, while the first electric field EF1 can have, for example, from 0.1 V/μm to 10 V/μm in a square wave with 1 kHz. Other configurations are possible.

The object of the invention is also met, according to the invention, by a second embodiment of a light filter. Instead of the first optical element and second optical element from the previously described embodiment, this light filter comprises a third optical element which in turn comprises a plurality of light absorbing transition dipole moments. Here also, the majority of transition dipole moments are aligned, at least in a first state, with a tolerance of at most 20° (preferably at most 10°) parallel to a third preferential direction which is selectable for the third optical element or fluctuate/vary around it. In this connection, the predicate “at least in a first state” includes several possibilities. First, there can be exactly one state. This is a permanent configuration. However, this wording also explicitly implies that there can be two or more states. In this case, the transition dipole moments are variable, e.g., via a guest-host liquid crystal cell, so that light which is incident into the third optical element is transmitted or at least partially absorbed depending on its incident direction relative to the third optical element and its polarization state.

The third optical element comprises a biaxially birefringent material so that, according to the invention, the three complex refractive indices of the three principal axes x, y, z differ from one another within the third optical element. The three basic linearly independent and, therefore, differing principal axes x, y, z preferably lie in a Cartesian coordinate system. Consequently, linearly polarized light or—particularly highly—elliptically polarized light which is incident into the light filter at least at an angle of 35° to the third preferential direction is at least 85% absorbed when the angle between the electric field of the linearly polarized light or of the long semi-axis of the elliptically polarized light and the incident direction, (both) projected onto the surface of the light filter, amounts to less than 20°.

Here, again, highly elliptically polarized light means that the ratios of the amounts of the semi-axes are at least 1:4, better yet at least 1:10 or more.

In this second embodiment of the invention, the light filter can also comprise a linear polarizing filter which is arranged upstream or downstream of the third optical element in direction of incidence. When a linear polarizing filter is arranged in front of the third optical element in direction of incidence, it provides for the linear polarization of the light incident on the third optical element. On the other hand, when a linear polarizing filter is arranged downstream of the third optical element in direction of incidence, it provides for the extinction of unwanted polarization components of the light emerging from the third optical element. Alternatively or additionally, a quarter-wave layer is also contemplated such as upon incidence of circularly polarized light with wavelength λ which is transformed into substantially linearly polarized light because of this layer.

As has already been mentioned, the three principal axes x, y, z differ from one another in such a way that they are linearly independent. The third optical element has a layer thickness d—more precisely, this is the layer thickness of the layer with the absorbing transition dipole moments. In a first preferred variant of the second embodiment, the biaxially birefringent material of the third optical element has, along the principal axes, the respective complex refractive indices nₓ=n₂−i*k₂, n_{y}=n₁−i*k₂ and n_{z}=n₁−i*k₁, and the latter satisfy the condition |n₁−n₂|*d≥λ/4, where k₁/k₂>10. The imaginary part is designated by “i”, n₁, n₂, n₃ are real refractive indices, and k₁, k₂, k₃ are the corresponding absorption indices.

The coordinate directions of the refractive indices nₓ, n_{y}, n_{z} relate exclusively to the orientation of the principal axes and are possibly inclined and/or rotated relative to a coordinate system of the display screen.

In a second preferred variant of the second embodiment, the biaxially birefringent material of the third optical element has, along the principal axes, the respective complex refractive indices nₓ=n₂−i*k₂, n_{y}=n₁−i*k₂ and n_{z}=n₃−i*k₁, and the latter satisfy the condition |n₁−n₂|*d≥λ/4, where k₁/k₂>10 und |n₂−n₃|≤|n₁−n₂|/2.

The inventive manner of operation of the second embodiment of the invention will be explained in the following.

A third optical element comprising a biaxially birefringent material or a third optical element of the second embodiment comprising such a material can also be interpreted purely notionally as a multilayer system having the layers of “transition dipole moments” and “type A retarder plate” alternating respectively. The layer with the transition dipole moments absorbs p-polarized light. If, as is preferred, the third preferential direction is perpendicular to the large surface of the optical element, the optimum protected view, that is, the optimum angle-dependent horizontal transmission limitation, is achieved for horizontal viewing angles which have a vertical viewing angle component of 0°. However, if the vertical viewing angle deviates from 0°, the protected view decreases for constant horizontal viewing angles. In this regard, reference is also made to the unwanted hourglass shape of transmission in the prior art which was mentioned in the description of the technical problem. Since, as was described, the notional layer with the transition dipole moments absorbs p-polarized light, the transmitted light is linearly s-polarized. The notional type A retarder plate converts the linearly polarized light into elliptically polarized light which can again be (at least partially) absorbed by a next (notional) layer of transition dipole moments, which improves the angle-dependent transmission limitation. There is, purely notionally, a plurality of “transition dipole moments” and “type A retarder plate” layers so that the angle-dependent transmission limitation is appreciably improved over the prior art because of the configuration according to the invention.

The production of a biaxial third optical element is carried out, for example, analogous to the production of known biaxial films. For this purpose, for example, LC mesogens are polymerized and subsequently doped with dichroic dye molecules or mixtures thereof.

A first exemplary production variant for a first, second or third optical element using the guest-host principal is based on mixtures of dichroic dyes or the combination of dichroic dye mixtures with liquid crystal mixtures or liquid crystal compounds and comprises the following steps for production (such as are described, for example, in U.S. Pat. No. 9,481,658 B2 or WO2021/177308 A1, paragraphs 37ff): a slightly birefringent or non-birefringent substrate is coated with a film which determines the alignment of the molecules relative to the surface, generally parallel to or perpendicular to the surface. Polymers, preferably polyvinyl alcohol (PVAL/PVOH) or polyimides (PI) are used for this purpose. Optionally, the surfaces can be optically treated or mechanically treated to improve the subsequent quality of the molecular alignment. The mixture of dichroic dye and liquid crystalline compounds or polymers is subsequently applied. Lastly, the side chains are condensed locally by irradiation of light so that they ensure birefringence along the surface.

An alternative, second production variant makes use of thermotropic, liquid crystalline dichroic dyes such as are described, for example, in JP2011-237513 A and comprises the following steps: production of the corresponding dyes, addition of a polar group, application of the dye mixture, and photoalignment and curing of the dye mixture by means of polarized light.

The following materials are contemplated by way of example for different production variants without claiming completeness:
as polymer substrate with little or no birefringence: preferably TAC;
as dichroic substances or mixtures: dichroic dyes (preferably azo dyes) or dichroic metal nanoparticles (preferably gold, silver, copper and aluminum); these are generally individual dyes or mixtures of typically up to three different dyes to enable absorption over substantial portions of the emitted spectrum;
for surface treatment by alignment of dyes or liquid crystalline substances: polymers, preferably polyvinyl alcohol or polyimides;
for thermotropic liquid crystalline compounds or polymers, reference is made by way of example to JP2011-237513 A;
as chemical groups for wetting which are bonded to the thermotropic liquid crystalline compounds or polymers (cross-linking): metaacryloyl groups, epoxy groups, oxetanyl groups and styrene groups, preferably methacryloylic groups; alternatively, these can be polymerizable liquid crystal compounds such as those described in JP 6268730 B2;
polymerizable liquid crystalline dichroic dyes: azo dyes.

The at least one dye comprises dye molecules, a transition dipole or transition dipole moment being advantageously associated with each dye molecule, i.e., each dye molecule corresponds to a transition dipole or transition dipole moment. A dye typically has a mass percentage of 0.01% to 10%, preferably 0.1% to 5%, of material of the respective layers of the relevant optical element. In special cases, the concentration in the case of liquid crystalline dichroic dyes can even reach 95%. Intermediate values are possible. The thickness of the layers preferably lies in the region of 0.2 μm to 50 μm, preferably in the region of 0.5 μm to 20 μm, all boundary values included. The dyes or dye mixtures for different layers within an optical element can, but need not, vary.

For both embodiments of the light filter according to the invention, the first, second or third preferential direction can advantageously in each case include an angle between 0° and 45° to a surface normal of the optical element, all boundary values included.

Further, in each configuration of the invention, the first (and, if present, second and third) preferential direction can vary over the surface area of the corresponding optical element. Within the meaning of the invention, the respective preferential direction is then the average weighted preferential direction determined across all values. The respective preferential direction of a transition dipole moment is advantageously selectable depending on its position in the respective optical element.

In a further preferred configuration of a first, second or third optical element, this optical element is divided into different regions along a selectable reference line, and every region can have its own regional preferential direction selected for it which applies to all of the transition dipole moments located within a region. All of the regional preferential directions differ pairwise and face in direction of an observer to within a tolerance of +/−10° at the maximum. Accordingly, within each applicable region, all of the transition dipole moments are aligned in each instance parallel to the applicable preferential direction within a tolerance of at most +/−10°. This arrangement has the advantage that the observer perceives a display screen with a light filter in the limited viewing mode as homogeneously illuminated.

In a second embodiment of the light filter, the light filter can also further comprise:
means for selectively generating a first electric field EF1 or a second electric field EF2,
a liquid crystal layer which is upstream or downstream of the third optical element and on which the first electric field EF1 or the second electric field EF2 acts and which, depending thereon, influences the polarization state of light passing through it, so that
the transmission characteristics of the light filter differ between a first operating mode B1 in which the first electric field EF1 is present and a second operating mode B2 in which the first electric field EF2 is present. Here also, more than two different electric fields can be generated corresponding to further possible operating modes; however, only one of the electric fields can be present at any one time.

For both embodiments of the light filter according to the invention, the switchable liquid crystal layer transmits light incident thereon substantially unchanged in a first switching state in the presence of the first electric field E1 and, in a second state, i.e., in the presence of the second electric field EF2, the light is circularly or elliptically polarized or the polarization of the light is rotated by 90°.

“Substantially” means here that the alignment of the liquid crystal molecules at the interfaces is determined by electric fields and surface-induced forces. Accordingly, the liquid crystal molecules are not aligned ideally, which leads to an (unwanted) change in polarization.

The invention becomes particularly significant when applied in an illumination device for, or at or in, display screens. Therefore, the invention also includes an illumination device for a display screen which can be operated in at least two operating modes, B1 for a free viewing mode and B2 for a limited viewing mode in which light is emitted in an angular range which is limited relative to the free viewing mode. This illumination device comprises:
a two-dimensionally extensive backlight which contains a light filter according to the first embodiment or second embodiment and radiates light,
a plate-shaped light guide which is located in front of the backlight in viewing direction and which has out-coupling elements on at least one of the large surfaces and/or within its volume,
illuminants arranged laterally on at least one narrow side of the light guide,
a linear polarizing filter arranged in front of the backlight or in front of the light guide in viewing direction, as a result of which light emanating from the backlight and passing through both the aforementioned light filter and the linear polarizing filter is limited with respect to its propagation directions,
wherein the backlight is switched on and the illuminants are switched off in operating mode B2, and wherein at least the illuminants, i.e., either the illuminants or both the illuminants and the backlight, are switched on in operating mode B1.

When a liquid crystal layer is contained in the light filter in the above-described illumination device, operating modes B1 and B2 correlate, respectively, with the states of the liquid crystal layer which are brought about by the first electric field EF1 and second electric field EF2. However, the above-described illumination device also allows switchability between the aforementioned operating modes when there is no liquid crystal layer in the light filter because switching can then be ensured exclusively via the change between backlight and illumination through the illuminants.

The invention further includes a display screen which can be operated in at least two operating modes, B1 for a free viewing mode and B2 for a limited viewing mode in which light is emitted in a viewing angle range which is limited for an observer relative to the free viewing mode. This display screen comprises:
a two-dimensionally extensive backlight which contains a light filter according to the first embodiment or second embodiment—in this instance always with an aforementioned liquid crystal layer—and radiates light, wherein the backlight is optionally constructed to be directly luminous,
a linear polarizing filter arranged in front of the backlight in viewing direction of the observer, as a result of which light which emanates from the backlight and passes through both the aforementioned light filter and the linear polarizing filter is limited with respect to its propagation directions, and
a transmissive imaging display unit which is arranged in front of the light filter in viewing direction, particularly in front of the backlight and/or in front of the polarizing filter,
wherein the second electric field (EF2) is present in operating mode B2 and the first electric field (EF1) is present in operating mode B1.

The linear polarizing filter is advantageously arranged in, or at, the transmissive imaging display unit or is a part thereof. Beyond this, it is possible that the light filter is integrated in the transmissive imaging display unit and then has, in particular, at least one substrate in common with the imaging display unit.

Finally, the invention comprises a further display screen which can be operated in at least two operating modes, B1 for a free viewing mode and B2 for a limited viewing mode in which light is emitted in a viewing angle range which is limited for an observer relative to the free viewing mode. This further display screen comprises:
an imaging display unit, e.g., an OLED panel, micro-LED panel, LCD panel or other type of display screen,
a light filter according to the invention according to the first embodiment or the second embodiment—in this instance always with an aforementioned liquid crystal layer—in front of the imaging display unit in viewing direction of the observer,
wherein the second electric field EF2 is present in operating mode B2, and the first electric field EF1 is present in operating mode B1.

A particular configuration variant can be implemented for an above-described display screen with transmissive imaging display unit, in particular with an LCD panel, which accordingly also has a backlight. The backlight is configured in such a way that it has essentially no symmetrical (e.g., around the vertical centerline from the observer's perspective) luminance distribution but, on the contrary, embodies an asymmetrical—e.g., in the horizontal—luminance distribution. In other words, the aforementioned backlight has an asymmetrical luminance distribution, the aforementioned asymmetry preferably being present with respect to the horizontal direction from the perspective of an observer.

This is advantageous in cases of use in vehicles because particularly light which would be emitted in direction of the front-seat passenger's window can be appreciably reduced, for example, to less than 10%, preferably less than 2.5%, of the peak brightness, by the design of the backlight from horizontal angles of about 25° or more relative to the perpendicular bisectors, while there exists a desirably high luminance in direction of the driver. In this way, bothersome reflections in the front seat passenger's window or possibly on the outside mirror closest to the front seat passenger are reduced or even prevented. Nevertheless, because of the light filter mounted in front of the imaging display unit, the display screen can be selectively operated such that either only the front seat passenger can view image contents (operating mode B2), such as for moving images, or both the driver and the front seat passenger can view image contents (operating mode B1) such as for navigational map material.

Further, it is possible in such a display screen to arrange a further, additional optical element—as with the first, second or third optical element—in front of the transmissive imaging display unit in viewing direction. In the event that the transmissive imaging display unit is an LCD panel which then emits the vertically linear polarized light appropriate, for example, for polarizing sunglasses, the transmission would be limited in this case upwardly and downwardly from the perspective of the observer so that reflections on the windshield are minimized.

Further, it is provided for an above-described display screen with a transmissive imaging display unit, particularly with an LCD panel, that a light filter according to the invention in the first embodiment or second embodiment—in this instance always with an aforementioned liquid crystal layer—can be arranged not only in front of the imaging display unit in viewing direction but also behind the imaging display unit in viewing direction.

In particular configurations, the light filter according to the invention is not mounted in front of the imaging display unit until later. In this way, when already existing imaging display units are used, the latter may be retrofitted so that they can be operated in at least two operating modes, B1 for a free viewing mode and B2 for a limited viewing mode.

Such a display screen is advantageously used in a mobile device, a motor vehicle, aircraft or watercraft, in a pay terminal or in an access system. Switching between the aforementioned operating modes can then be carried out in order to protect sensitive data, i.e., to make it visible to only one observer or, alternatively, to display image contents to a plurality of observers simultaneously.

In principle, the performance capability of the invention is unaffected by varying, within limits, the above-described parameters. It will be understood that the features mentioned above and those yet to be explained below may be used not only in the stated combinations but also in other combinations or alone without departing from the scope of the present invention.

### BRIEF DESCRIPTION OF THE DRAWINGS

The invention will be explained in more detail in the following with reference to drawings which also disclose key features of the invention. These embodiment examples are provided merely to be illustrative and should not be considered as restrictive. For example, a description of an embodiment example having a plurality of elements or components should not be interpreted to mean that all of these elements or components are necessary for its implementation. On the contrary, other embodiment examples may also contain alternative elements and components, fewer elements or components, or additional elements or components. Elements or components of different embodiment examples can be combined with one another unless otherwise stated. Modifications and alterations which are described for one of the embodiment examples may also be applicable to other embodiment examples. Like or comparable elements in the various figures are designated by the same reference numerals and not mentioned repeatedly so as to prevent repetition. The drawings show:

FIG. 1A the schematic diagram of an exemplary two-dimensional angle-dependent representation of the transmission of a prior art light filter;

FIG. 1B the schematic diagram of an exemplary two-dimensional angle-dependent representation of the transmission of a light filter in combination with a biaxial retarder plate from the prior art;

FIG. 2A the schematic diagram of a construction of a light filter in a first embodiment;

FIG. 2B a schematic diagram for explaining the projection of the long semi-axis of elliptical light and its incident direction onto a plane;

FIG. 3A the schematic diagram of an expanded construction of a light filter for selectively changing the transmission characteristics of the light filter;

FIG. 3B the schematic diagram of an exemplary two-dimensional angle-dependent representation of the transmission of a light filter in the first embodiment;

FIG. 4 the schematic diagram for explaining the complex refractive index of a biaxial third optical element;

FIG. 5 the schematic diagram of an exemplary two-dimensional angle-dependent representation of the transmission of a light filter in the second embodiment under a first condition;

FIG. 6 the schematic diagram of an exemplary two-dimensional angle-dependent representation of the transmission of a light filter in the second embodiment under a second condition;

FIG. 7 the schematic diagram of an exemplary angle-dependent representation of the transmission of different light filters in horizontal direction at a vertical angle of 0°;

FIG. 8 the schematic diagram of an exemplary angle-dependent representation of the transmission of different light filters in horizontal direction at a vertical angle of 45°;

FIG. 9 the schematic diagram of the construction of an illumination device for display screens using a light filter in the first embodiment or second embodiment;

FIG. 10 the schematic diagram of a first construction of a display screen which can be operated in at least two operating modes, B1 for a free viewing mode and B2 for a limited viewing mode, using a light filter in the first embodiment or second embodiment;

FIG. 11 the schematic diagram of a second construction of a display screen which can be operated in at least two operating modes, B1 for a free viewing mode and B2 for a limited viewing mode, using a light filter in the first embodiment or second embodiment; and

FIG. 12 the schematic diagram of a third construction of a display screen which can be operated in at least two operating modes, B1 for a free viewing mode and B2 for a limited viewing mode, using a light filter in the first embodiment or second embodiment.

### DETAILED DESCRIPTION OF THE DRAWINGS

The drawings are not to scale and are merely schematic depictions.

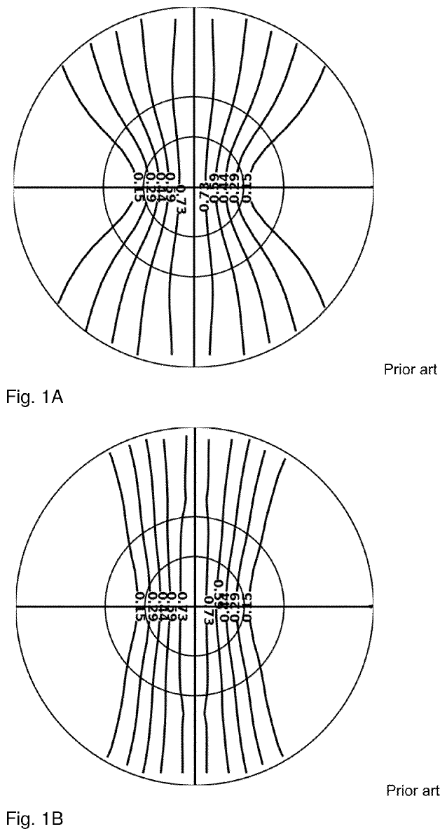

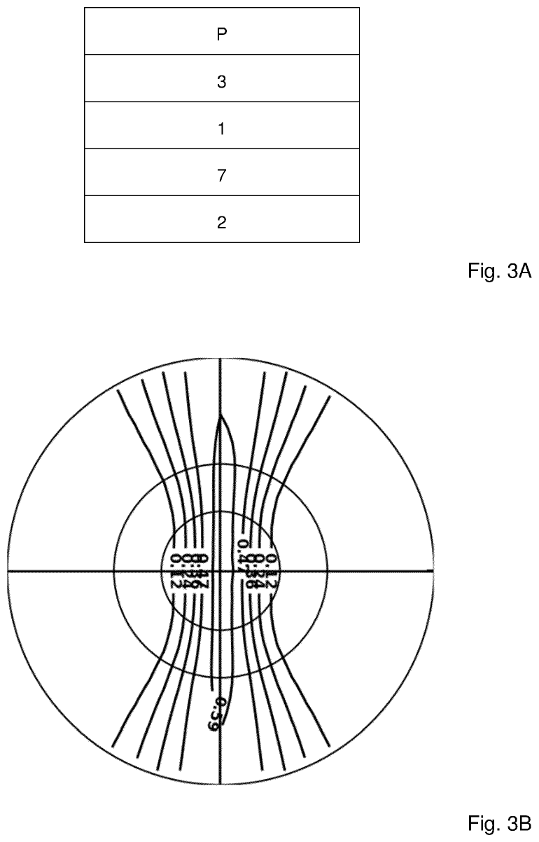

In FIGS. 1A, 1B, 3A, 5 and 6, which are exemplary two-dimensional angle-dependent representations of the transmission of light filters, the numbers associated with the lines represent the transmission in the corresponding angle pair in polar coordinates normalized to “1”. For example, the number 0.12 in FIG. 3 corresponds to a transmission of 12% for the corresponding direction.

In light filters known from the prior art in which the directional selectivity is achieved via the polarization characteristics, the two-dimensional angle-dependent representation of the transmission in a polar coordinate system takes on the unwanted shape of an hourglass when the absorption of the electric field takes place perpendicular to the film surface. This state of affairs is shown schematically in FIG. 1A. Accordingly, the protected view effect of this operating principle remains limited without further improvements. Therefore, owing to the hourglass shape, the transmission, as measurement for the protected view, always has higher values for vertical viewing angles greater than 5° than for vertical viewing angles less than +/−5° for light that is linearly polarized along the horizontal direction. This is clearly shown in FIG. 1A. The term “vertical” is thought of here as an exemplary reference for an observer standing or sitting in front of, and looking at, a light filter. In this case, the line joining both of the observer's eyes would define the horizontal direction as reference. Correspondingly, the vertical direction, as reference, lies perpendicular thereto.

For this reason, in the prior art, considerations led to combining such light filters with a type B retarder layer (B-plate). In this regard, FIG. 1B shows the schematic diagram of an exemplary two-dimensional angle-dependent representation of the transmission of such a light filter combined with a biaxial retarder plate from the prior art. While a certain improvement is achieved, the results are not satisfactory for every case of application.

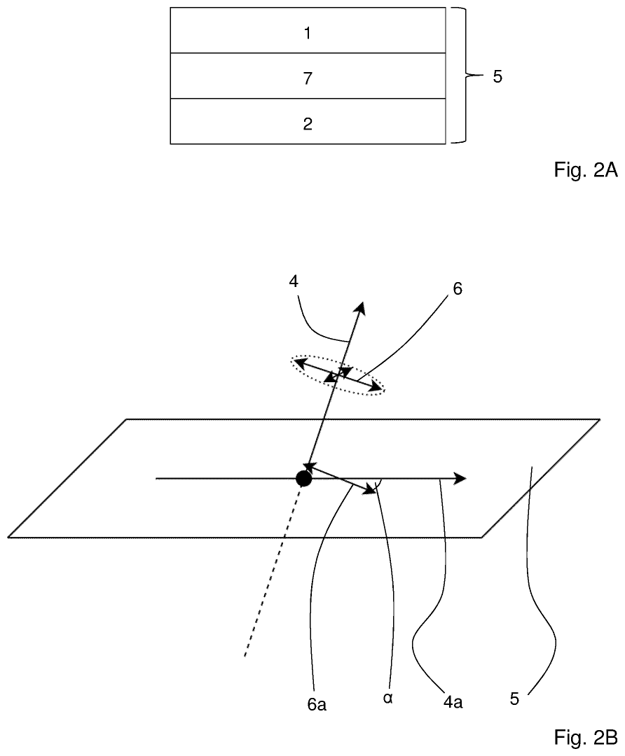

By contrast, FIG. 2A schematically shows the exemplary construction of a light filter 5 in a first embodiment.

Such an exemplary light filter 5 comprises, in a first embodiment, a first optical element 1 and a second optical element 2, each of the two optical elements 1, 2 in turn comprising, respectively, a plurality of light absorbing transition dipole moments, and the two optical elements 1, 2 are arranged in a stacked manner, i.e., as elements of a layer stack, with respect to an incident direction 4 of light. The majority of transition dipole moments is oriented in each instance, at least in a first state with a tolerance of at most 20° (preferably at most 10°), parallel to a first preferential direction which is selectable for the first optical element 1 and parallel to a second preferential direction which is selectable for the second optical element 2 or fluctuates or varies around the latter. In this connection, the predicate “at least in a first state” includes several possibilities. First, there can be exactly one state which is a permanent configuration. However, this wording also explicitly implies that there can be two or more states. In this case, the transition dipole moments are variable. In this way, light which is incident into the first optical element 1 or into the second optical element 2 is transmitted or at least partially absorbed depending on its incident direction relative to the respective optical element 1, 2 and its polarization state. Arranged between the first optical element 1 and second optical element 2 is a retarder layer 7 in the form of a C-plate or A-plate, for example, a half-wave layer. In every case, the phase shift must be greater than a quarter-wavelength so that linearly polarized light or—particularly highly—elliptically polarized light which is incident into the light filter 5 at least at an angle of 35° to the first preferential direction or second preferential direction is at least 85% absorbed, where the angle between the electric field of the linearly polarized light or of the long semi-axis 6 of the elliptically polarized light and the incident direction 4, (both) projected onto the surface of the light filter 5, amounts to less than 20°.

To facilitate comprehension, FIG. 2B shows the schematic representation of the projection of the long semi-axis 6 of exemplary elliptical light and the incident direction 4 thereof onto a plane which corresponds to the surface of the light filter 5. The projection 6a of the long semi-axis 6 and the projection 4a of the incident direction 4 form angle α. This angle α should be less than 20° for the means-effect relationships according to the invention to be effective.

The means-effect relationships for improving protected viewing based on the above-described combination, according to the invention, of the first optical element 1, retarder layer 7 (A-plate or C-plate) and second optical element 2 can be illustrated conceptually as follows: it is assumed for purposes of explanation that the absorbing transition dipole moments are aligned in each instance substantially perpendicular to the surface of an optical element, i.e., the respective preferential direction lies perpendicular to the surface thereof (which is a preferred case). The first optical element 1 absorbs substantially p-polarized electric field components. When linearly polarized light is incident into the first optical element 1, the light is maximally absorbed when the light is polarized exclusively in the plane of incidence. The larger the angle between the plane of incidence and the polarization or, correspondingly, the vertical viewing angle, the greater the transmission. The two-dimensional angle-dependent diagram has an hourglass shape for the first optical element 1, per se. A retarder layer 7, as A-plate or C-plate, whose extraordinary axis is oriented perpendicular to or parallel to the surface is now inserted after the first optical element 1. The light transmitted by the retarder layer 7 is now not exclusively polarized along a principal axis of the retarder layer 7 so that light which is s-polarized through the retarder layer 7 is at least partially transformed into p-polarized light which can be absorbed by the subsequent second optical element 2. Accordingly, the original hourglass shape in the above-mentioned diagram changes more to a rectangular shape, which is desired.

FIG. 3B shows the schematic depiction of an exemplary two-dimensional angle-dependent representation of the transmission of a light filter in the first embodiment. The narrower waist and the lower transmission values compared with the hourglass shapes in FIGS. 1a and 1b are apparent.

The first preferential direction and second preferential direction can also be identical or may differ in orientation only by a few degrees (at most 10°) for the first optical element 1 and second optical element 2. This is a preferred case which is assumed for all of the examples described in the drawings.

FIG. 3A further shows the schematic diagram of an expanded construction of a light filter 5 for selectively changing the transmission characteristics of this light filter 5. A light filter 5 which is expanded in this way additionally comprises:
means (not shown in the drawings) for selectively generating at least a first electric field EF1 or a second electric field EF2, for example, two ITO layers with control electronics,
a liquid crystal layer 3 which is upstream or downstream of the first optical element 1 and/or second optical element 2 and on which the first electric field EF1 or the second electric field EF2 acts and which, depending thereon, influences the polarization state of light passing through it so that
the transmission characteristics of the light filter 5 differ between a first operating mode B1 in which the first electric field EF1 is present and a second operating mode B2 in which the first electric field EF2 is present.

A retarder layer 7 (A-plate or C-plate) is provided in this case, too. The light filter 5 can further comprise a polarizing filter P which is upstream or downstream of the first optical element 1 or second optical element 2 seen in the direction of incidence as is shown in FIG. 3A.

In a preferred configuration, the light penetrating the liquid crystal layer 3 is transmitted substantially unchanged in the presence of the second electric field EF2, while the incident light is circularly or elliptically polarized, or the polarization of the light is rotated by 90°, in the presence of the first electric field EF1.

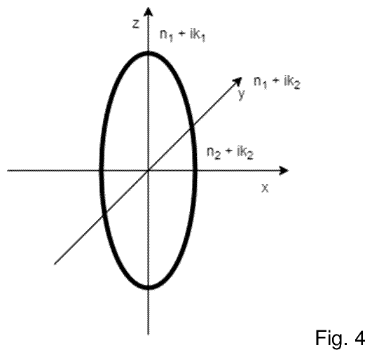

FIG. 4 further shows a schematic diagram for explaining the complex refractive index of a third optical element comprising a biaxially birefringent material, namely, with reference to a light filter 5a in a second embodiment. An exemplary light filter 5a comprises a third optical element comprising, in turn, a plurality of light absorbing transition dipole moments. The majority of transition dipole moments are aligned, at least in a first state with a tolerance of at most 20° (preferably at most 10°), parallel to a third preferential direction which is selectable for the third optical element or fluctuates or varies around the latter. In this connection, the predicate “at least in a first state” includes several possibilities. First, there can be exactly one state which is a permanent configuration. However, this wording also explicitly implies that there can be two or more states. In this case, the transition dipole moments are variable. Accordingly, light which is incident into the third optical element is transmitted or at least partially absorbed depending on its incident direction relative to the third optical element and its polarization state. As already mentioned, the third optical element comprises a biaxially birefringent material so that the three complex refractive indices of the three (different and linearly independent) principal axes within the third optical element differ from one another. The three basic principal axes x, y, z preferably lie in a Cartesian coordinate system. As a result, linearly polarized light or—particularly highly—elliptically polarized light which is incident into the light filter 5a in a second embodiment at least at an angle of 35° to the third preferential direction is at least 85% absorbed, the angle between the electric field of the linearly polarized light or of the long semi-axis of the elliptically polarized light and the incident direction, (both) projected on the surface of the light filter 5a, amounting to less than 20°.

Referring to FIG. 4, by way of example, λ=|(n₁−n₂)|*d for a wavelength retardation of light having wavelength λ, (e.g., for λ=550 nm or 580 nm or for all wavelengths of the visible wavelength spectrum).

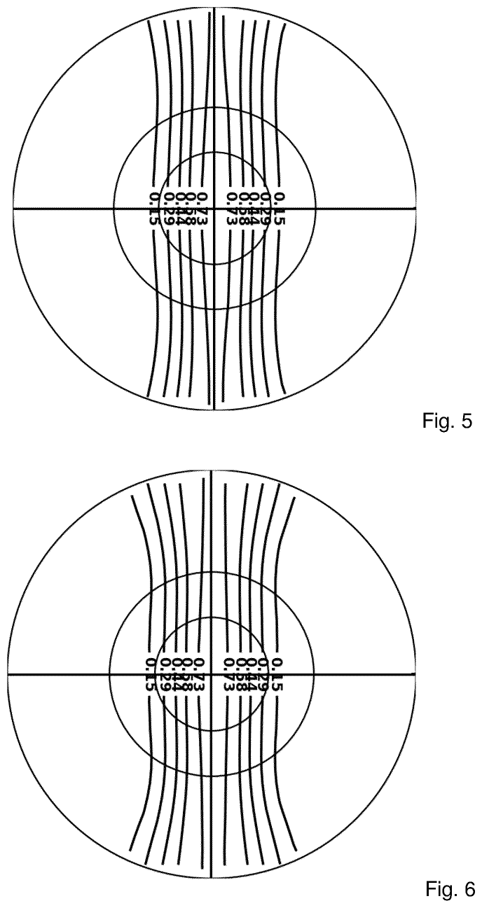

Results achievable, by way of example, with the second embodiment are shown in FIG. 5 which is a schematic diagram showing an exemplary two-dimensional angle-dependent representation of the transmission of a light filter 5a in the second embodiment under the first condition λ/2=|(n₁−n₂)|·d for a wavelength retardation of light with wavelength λ.

In a first preferred variant of the second embodiment, when the three different principal axes x, y, z of the third optical element have the respective complex refractive indices nₓ=n₂−i*k₂, n_{y}=n₁−i*k₂ and n_{z}=n₁−i*k₁, they obey the condition |n₁−n₂|*d≥λ/4, where k₁/k₂>10. In this regard, the retardation was set by way of example at 5/3*λ for the conditions respecting the results shown in FIG. 5. The layer thickness of the absorbing transition dipole moments is also designated here as d.

The coordinate directions of the refractive indices relate exclusively to the orientation of the principal axes and are possibly inclined and/or rotated relative to a coordinate system of a display screen at which a light filter 5a in the second embodiment is mounted or installed.

In a second preferred variant of the second embodiment, when the three different principal axes x, y, z of the third optical element have the respective complex refractive indices nₓ=n₂−i*k₂, n_{y}=n₁−i*k₂ and n_{z}=n₃−i*k₁, they obey the condition |n₁−n₂|*d≥λ/4, where k₁/k₂>10 und |n₂−n₃|≤|n₁−n₂|/2. In this regard, FIG. 6 is a schematic diagram of an exemplary two-dimensional angle-dependent representation of the transmission of a light filter in the second embodiment under the second condition λ/4=|n₁−n₂|*d for the wavelength retardation of light with wavelength λ. Here, the retardation was set by way of example at 5/6*λ for the conditions respecting the results shown in FIG. 6.

The light filter 5a in its second embodiment can also additionally comprise:
means for selectively generating at least a first electric field EF1 or a second electric field EF2,
a liquid crystal layer 3 which is upstream or downstream of the third optical element and on which the first electric field EF1 or the second electric field EF2 acts and which, depending thereon, influences the polarization state of light passing through it, so that
the transmission characteristics of the light filter 5 differ between a first operating mode B1 in which the first electric field EF1 is present and a second operating mode B2 in which the first electric field EF2 is present.

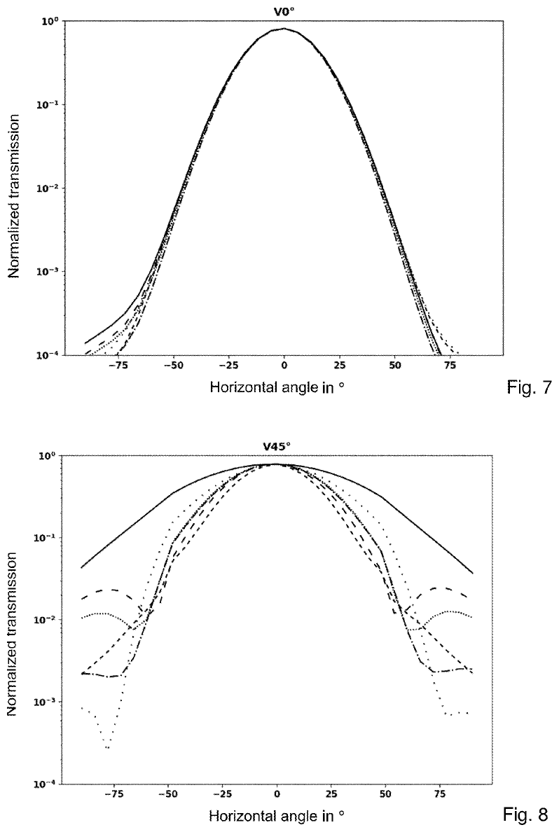

The advantageous effects of the solutions according to the invention are shown in FIG. 7 and FIG. 8. FIG. 7 shows the schematic depiction of an exemplary angle-dependent representation of the transmission (normalized to a maximum of 10°=1) of different light filters in horizontal direction at, in each instance, a vertical angle of 0° and, in FIG. 8, at a vertical angle of 45°.

The following key applies to FIG. 7 and FIG. 8:

| | |
|---|---|
| Solid line | Prior-art linear polarizing filter combined with optical |
| | filter, generating the directional selectivity via the |
| | polarization characteristics |
| Large-spaced dotted line | Prior-art linear polarizing filter combined with optical |
| | filter, generating the directional selectivity via the |
| | polarization characteristics, and type B retarder layer |
| Dash-dot line | An exemplary first embodiment of the light filter |
| | (variant 1) |
| Closely-spaced dashed line | A further exemplary first embodiment of the light filter |
| | (variant 2), used in this case with an additional type B |
| | retarder layer |
| Closely-spaced dotted line | An exemplary second embodiment of the light filter |
| | (variant 1) |
| Large-spaced dashed line | A further exemplary second embodiment of the light |
| | filter (variant 2) |

As is wanted and as is shown in FIG. 7, the steps according to the invention have a negligible influence on transmission with a vertical angle of 0°, particularly over the entire horizontal angular spectrum in question. All transmission values below 10⁻² are generally very well suited for practical applications, for which reason the differences between the various light filters are inconsequential at angles amounting to more than approximately 60°.

In contrast, the differences in transmission with a vertical angle of 45° are striking over the entire horizontal angular spectrum in question as is shown in FIG. 8. Compared with prior-art light filters, all of the exemplary configurations of the light filters described herein show an appreciably greater reduction in transmission in the (horizontal) angular ranges of −50° to −25° and 25° to 50° that are particularly important for various applications.

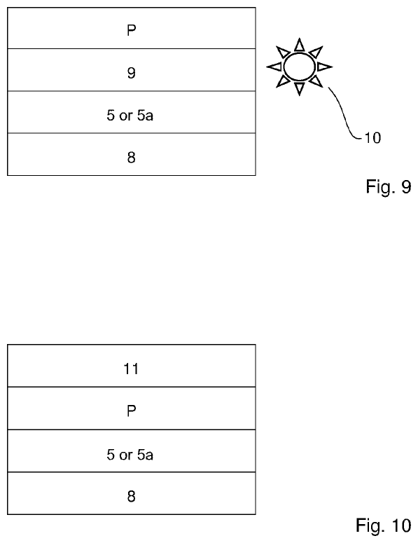

The invention becomes especially significant when applied in an illumination device for, or at or in, display screens. In this respect, FIG. 9 shows the schematic diagram of the construction of an illumination device for display screens using a light filter 5 or 5a of the first embodiment or second embodiment.

An illumination device for a display screen which can be operated in at least two operating modes, B1 for a free viewing mode and B2 for a limited viewing mode in which light is emitted in an angular range which is limited relative to the free viewing mode comprises:
a two-dimensionally extensive backlight 8 which contains a light filter 5 or 5a according to the first embodiment or second embodiment and emits light,
a plate-shaped light guide 9 which is located in front of the backlight 8 in viewing direction of an observer and which has out-coupling elements on at least one of the large surfaces and/or within its volume,
illuminants 10 arranged laterally on at least one narrow side of the light guide 9, and
a linear polarizing filter P arranged in front of the backlight 8 or in front of the light guide 9 in viewing direction, as a result of which light emanating from the backlight 8 and passing through the light filter 5 or 5a and through the linear polarizing filter P is limited with respect to its propagation directions,
wherein the backlight 8 is switched on and the illuminants 10 are switched off in operating mode B2, and wherein at least the illuminants 10 are switched on in operating mode B1.

When a liquid crystal layer 3 is contained in the light filter 5 or 5a in the above-described illumination device, operating modes B1 and B2 correlate, respectively, with the states of the liquid crystal layer 3 which are brought about by the first electric field EF1 and second electric field EF2, respectively. In this case, the light efficiency in operating mode B1 is increased because light from the backlight 8, transmitted by the light filters 5 or 5a, as well as light from the light guide 9 are laterally radiated when both the illuminants 10 and the backlight 8 are switched on in operating mode B1. However, the above-described illumination device also allows switchability between the aforementioned operating modes when there is no liquid crystal layer 3 in the light filter 5, 5a because switching can then be ensured solely via the change between backlight 8 and illumination through the illuminants 10.

The invention further includes a display screen which can be operated in at least two operating modes, B1 for a free viewing mode and B2 for a limited viewing mode in which light is emitted in a viewing angle range which is limited for an observer relative to the free viewing mode. This is shown in FIG. 10 as a schematic diagram of a first construction of such a display screen. Such a display screen comprises:
a two-dimensionally extensive backlight 8 which contains a light filter 5 or 5a according to the first embodiment or second embodiment—in this instance always with an aforementioned liquid crystal layer 3—and emits light, wherein the backlight 8 is optionally constructed to be directly luminous (e.g., as matrix backlight),
a linear polarizing filter P arranged in front of the backlight 8 in a viewing direction of the observer, as a result of which light which emanates from the backlight 8 and passes through the light filter 5 or 5a and then through the linear polarizing filter P is limited with respect to its propagation directions, and
a transmissive imaging display unit 11 (preferably an LCD panel) which is arranged in front of the backlight 8 in viewing direction and/or in front of the polarizing filter P,
the second electric field (EF2) is present in operating mode B2, and the first electric field (EF1) is present in operating mode B1.

The linear polarizing filter P is advantageously arranged in or at the transmissive imaging display unit 11 or is a part thereof.

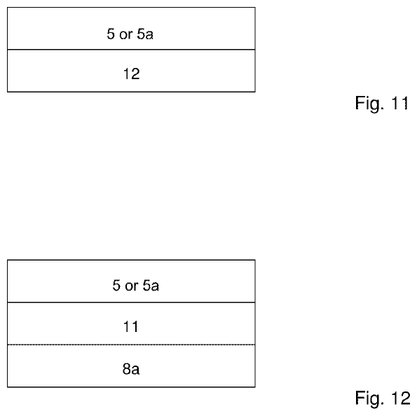

Finally, the invention comprises yet a further display screen with a second construction which can be operated in at least two operating modes, B1 for a free viewing mode and B2 for a limited viewing mode in which light is emitted in a viewing angle range which is limited for an observer relative to the free viewing mode. Such a display screen is shown as a schematic diagram in FIG. 11 and comprises:
an imaging display unit 12, e.g., an OLED panel, micro-LED panel, LCD panel or other type of display screen,
a light filter 5 or 5a according to the invention according to the first embodiment or the second embodiment—in this case always with an aforementioned liquid crystal layer 3—in front of the imaging display unit 12 in a viewing direction of the observer, wherein the second electric field EF2 is present in operating mode B2, and the first electric field EF1 is present in operating mode B1, and
optionally, a polarizing filter P (not shown in the drawing) and/or a retarder layer, preferably a quarter-wave type retarder layer (which generates substantially linearly or highly elliptically polarized light from circularly polarized light) between the imaging display unit 12 and the light filter 5 or 5a according to the invention.

Finally, FIG. 12 shows the schematic diagram of a third construction of a display screen which can be operated in at least two operating modes, B1 for a free viewing mode and B2 for a limited viewing mode, using a light filter 5 or 5a of the first embodiment or second embodiment. This configuration variant of the third construction can be implemented for an above-described display screen with transmissive imaging display unit 11, in particular with an LCD panel, which accordingly also has a backlight 8a. The backlight 8a is configured in such a way that, by design, it has essentially no luminance distribution that is symmetrical around the vertical centerline from the observer's perspective but, on the contrary, embodies an asymmetrical luminance distribution in the horizontal. This is possible, for example, using direction turning films and/or asymmetrical diffusers and/or asymmetrical louver filters. In other words, the aforementioned backlight 8a has an asymmetrical luminance distribution, and the aforementioned asymmetry is provided preferably with respect to the horizontal direction from the perspective of an observer.

This third construction of a display screen is advantageous in cases of use in vehicles because particularly light which would be emitted, say, in direction of the front-seat passenger's window can then be appreciably reduced, for example, to less than 10%, preferably less than 2.5%, of the peak brightness, by the design of the backlight 8a from horizontal angles of about 25 degrees or more (relative to the perpendicular bisectors), while there exists a desired high luminance in direction of the driver. In this way, bothersome reflections in the front seat passenger's window or possibly on the outside mirror closest to the front seat passenger are reduced or even prevented. Nevertheless, because of the light filter 5 or 5a mounted in front of (or possibly also behind) the imaging display unit 11, the display screen can be selectively operated such that either only the front seat passenger can view image contents (operating mode B2), such as for moving images, or both the driver and the front seat passenger can view image contents (operating mode B1) such as for navigational map material.

The invention meets the above-stated object. A light filter having an optical element has been described in which light that is incident into the optical element is transmitted or is partially or entirely absorbed depending on its incident direction and its polarization characteristics. By means of the light filters which utilize the optical element, the transmission of light is influenced in an angle-dependent manner—optionally perpendicularly with reference to a sitting or standing observer—and switching can be carried out optionally between at least two operating states. At the same time, it has been achieved that transmission for vertical viewing angles greater than 5° is reduced (i.e., to improve the protected view), while the transmission for vertical viewing angles remains less than 5°.

The invention described above can advantageously be used in combination with an imaging display unit anywhere that confidential data are displayed and/or entered, such as when entering a PIN number or displaying data in automatic teller machines or payment terminals or for entering passwords or when reading emails on mobile devices. As was described above, the invention can also be applied in passenger cars to selectively withhold distracting image contents from the driver or passenger.

### REFERENCE CHARACTERS

1 first optical element
2 second optical element
3 liquid crystal layer
4 incident direction of light
4a projection of the incident direction 4
5 light filter in a first embodiment
5a light filter in a second embodiment
6 long semi-axis of elliptically polarized light
6a projection of the long semi-axis 6
7 retarder layer
8 backlight
8a backlight with asymmetrical luminance distribution
9 light guide
10 illuminant
11 transmissive imaging display unit
12 imaging display unit
P polarizing filter (linear)

1. A light filter comprising;
a first optical element and
a second optical element,
wherein each of the two optical elements includes a plurality of light absorbing transition dipole moments,
wherein the two optical elements are arranged in a stacked manner with respect to an incident direction of light,
wherein for each of the first optical element and the second optical element, a majority of transition dipole moments are aligned, at least in a first state, with a tolerance of at most 20°, parallel to a first preferential direction which is selectable for the first optical element and parallel to a second preferential direction which is selectable for the second optical element or fluctuate/vary around them, so that light which is incident into the first optical element or into the second optical element is transmitted or at least partially absorbed depending on its incident direction relative to the respective optical element and its polarization state, and
there is arranged between the first optical element and the second optical element a retarder layer in the form of a C-plate or A-plate with which a phase shift greater than a quarter-wavelength is generated for a given wavelength λ, so that linearly polarized light or elliptically polarized light which is incident into the light filter at least at an angle of 35° to the first preferential direction or second preferential direction is at least 85% absorbed when the angle between the electric field of the linearly polarized light or of the long semi-axis of the elliptically polarized light and the incident direction, projected onto the surface of the light filter, amounts to less than 20°.

2. The light filter according to claim 1, further comprising:
a first electric field generator or a second electric field generator,
a liquid crystal layer (3) which is upstream or downstream of the first optical element and/or the second optical element and on which the first electric field or the second electric field acts and which, depending thereon, influences the polarization state of light passing through it so that transmission characteristics of the light filter differ between a first operating mode B1 in which the first electric field is present and a second operating mode B2 in which the first electric field is present.

3. Alight filter comprising;
a third optical element which in turn comprises a plurality of light absorbing transition dipole moments,
wherein a majority of transition dipole moments of the third optical element are aligned, at least in a first state, with a tolerance of at most 20° parallel to a third preferential direction which is selectable for the third optical element or fluctuate or vary around it, so that light which is incident into the third optical element is transmitted or at least partially absorbed depending on its incident direction relative to the third optical element and its polarization state,
wherein:
the third optical element comprises a biaxially birefringent material so that the three complex refractive indices of the three principal axes differ from one another within the third optical element, so that linearly polarized or elliptically polarized light which is incident into the light filter at least at an angle of 35° to the third preferential direction is at least 85% absorbed when the angle between the electric field of the linearly polarized light or of the long semi-axis (6) of the elliptically polarized light and the incident direction, projected onto the surface of the light filter, amounts to less than 20°.

4. The light filter according to claim 3, wherein the three principal axes of the third optical element have respective complex refractive indices nₓ=n₂−i*k₂, n_{y}=n₁−i*k₂ and n_{z}=n₁−i*k₁, and they satisfy the condition |n₁−n₂|*d≥λ/4, where k₁/k₂>10.

5. The light filter according to claim 3, wherein the three principal axes of the third optical element have the respective complex refractive indices nₓ=n₂−i*k₂, n_{y}=n₁−i*k₂ and n_{z}=n₃−i*k₁, the latter satisfy the condition |n₁−n₂|*d≥λ/4, where k₁/k₂>10 und |n₂−n₃|≤|n₁−n₂|/2.

6. The light filter according to claim 3, further comprising:
a first electric field generator or a second electric field generator,
a liquid crystal layer which is upstream or downstream of the third optical element and on which the first electric field or the second electric field acts and which, depending thereon, influences the polarization state of light passing through it, so that transmission characteristics of the light filter differ between a first operating mode B1 in which the first electric field is present and a second operating mode B2 in which the first electric field is present.

7. An illumination device for a display screen which can be operated in at least two operating modes, B1 for a free viewing mode and B2 for a limited viewing mode in which light is emitted in an angular range which is limited relative to the free viewing mode, comprising:
a two-dimensionally extensive backlight which contains a light filter according to claim 1 and radiates light,
a plate-shaped light guide which is located in front of the backlight in a viewing direction of an observer and which has out-coupling elements on at least one of the large surfaces and/or within its volume,
illuminants arranged laterally on at least one narrow side of the light guide, and
a linear polarizing filter arranged in front of the backlight or in front of the light guide in a viewing direction, as a result of which light emanating from the backlight and passing through both the light filter and the linear polarizing filter is limited with respect to its propagation directions,
wherein the backlight is switched on and the illuminants are switched off in operating mode B2, and wherein at least the illuminants are switched on in operating mode B1.

8. A display screen which can be operated in at least two operating modes, B1 for a free viewing mode and B2 for a limited viewing mode in which light is emitted in a viewing angle range which is limited for an observer relative to the free viewing mode, comprising:
a two-dimensionally extensive backlight which contains a light filter according claim 2 and radiates light,
a linear polarizing filter arranged in front of the backlight in a viewing direction of the observer, as a result of which light which emanates from the backlight and passes through the light filter and the linear polarizing filter is limited with respect to its propagation directions, and
a transmissive imaging display unit which is arranged in front of the light filter in the viewing direction,
wherein the second electric field is present in operating mode B2 and the first electric field is present in operating mode B1.

9. The display screen according to claim 8, wherein the linear polarizing filter is arranged in the transmissive imaging display unit or is a part thereof.

10. A display screen which can be operated in at least two operating modes, B1 for a free viewing mode and B2 for a limited viewing mode in which light is emitted in a viewing angle range which is limited for an observer relative to the free viewing mode, comprising:
an imaging display unit,
a light filter according to claim 2 in front of the imaging display unit in a viewing direction of the observer,
wherein the second electric field is present in operating mode B2, and wherein the first electric field is present in operating mode B1.

11. A display screen which can be operated in at least two operating modes, B1 for a free viewing mode and B2 for a limited viewing mode in which light is emitted in a viewing angle range which is limited for an observer relative to the free viewing mode, comprising:
a transmissive imaging display unit,
a backlight which is arranged downstream of the transmissive imaging display unit in a viewing direction of the observer and which has an asymmetrical luminance distribution,
a light filter according to claim 2,
wherein the second electric field is present in operating mode B2, and wherein the first electric field is present in operating mode B1.

12. A display screen according to claim 11, wherein the asymmetry is present with respect to the horizontal direction as viewed by an observer.

13. A display screen which can be operated in at least two operating modes, B1 for a free viewing mode and B2 for a limited viewing mode in which light is emitted in a viewing angle range which is limited for an observer relative to the free viewing mode, comprising:
a two-dimensionally extensive backlight which contains a light filter according to claim 6 and radiates light,
a linear polarizing filter arranged in front of the backlight in a viewing direction of the observer, as a result of which light which emanates from the backlight and passes through the light filter and the linear polarizing filter is limited with respect to its propagation directions, and
a transmissive imaging display unit which is arranged in front of the light filter in the viewing direction,
wherein the second electric field is present in operating mode B2 and the first electric field is present in operating mode B1.

14. The display screen according to claim 13, wherein the linear polarizing filter is arranged in the transmissive imaging display unit or is a part thereof.

15. A display screen which can be operated in at least two operating modes, B1 for a free viewing mode and B2 for a limited viewing mode in which light is emitted in a viewing angle range which is limited for an observer relative to the free viewing mode, comprising:
an imaging display unit,
a light filter according to claim 6 in front of the imaging display unit in a viewing direction of the observer,
wherein the second electric field is present in operating mode B2, and wherein the first electric field is present in operating mode B1.

16. A display screen which can be operated in at least two operating modes, B1 for a free viewing mode and B2 for a limited viewing mode in which light is emitted in a viewing angle range which is limited for an observer relative to the free viewing mode, comprising:
a transmissive imaging display unit,
a backlight which is arranged downstream of the transmissive imaging display unit in a viewing direction of the observer and which has an asymmetrical luminance distribution,
a light filter according to claim 6,
wherein the second electric field is present in operating mode B2, and wherein the first electric field is present in operating mode B1.

17. The display screen according to claim 16, wherein the asymmetry is present with respect to the horizontal direction as viewed by an observer.
